(19) United States
(12) Patent Application Publication
(10) Pub. No.: US 2026/0018597 A1
(43) Pub. Date: Jan. 15, 2026

(54) ANODE FOR ALL-SOLID-STATE BATTERY, ALL-SOLID-STATE BATTERY INCLUDING THE SAME, AND METHOD OF MANUFACTURING ALL-SOLID-STATE BATTERY

(71) Applicant: SAMSUNG ELECTRONICS CO., LTD., Suwon-si (KR)

(72) Inventors: SUNG HEO, Suwon-si (KR); MYUNG JIN LEE, Suwon-si (KR); SEONGYONG PARK, Suwon-si (KR); DONGJIN YUN, Suwon-si (KR)

(73) Assignee: SAMSUNG ELECTRONICS CO., LTD., Suwon-si (KR)

(21) Appl. No.: 19/007,030

(22) Filed: Dec. 31, 2024

(30) Foreign Application Priority Data
Jul. 12, 2024 (KR) 10-2024-0092558

(51) Int. Cl. H01M 4/36; H01M 4/02; H01M 4/38; H01M 10/0562

(52) U.S. Cl. CPC H01M 4/366; H01M 4/382; H01M 10/0562; H01M 2004/027

(57) ABSTRACT

Provided is an anode for an all-solid-state battery including an anode layer, and an interface layer on the anode layer, wherein the anode layer includes an anode active material, and wherein the interface layer includes a metal oxynitride satisfying MₓN_{y}O_{z}, where, Mis one or more of silicon (Si), aluminum (Al), and hafnium (Hf), 0<x<1, 0<y<1, 0<z<1, and x+y+z=1.

### CROSS-REFERENCE TO RELATED APPLICATION

This application claims priority to Korean Patent Application No. 10-2024-0092558, filed on Jul. 12, 2024, in the Korean Intellectual Property Office, the disclosure of which is incorporated herein by reference in its entirety.

### BACKGROUND

### 1. Field

Embodiments of the present disclosure relate to an anode for an all-solid-state battery, an all-solid-state battery including the same, and a method of manufacturing an all-solid-state battery.

### 2. Description of Related Art

A lithium-ion battery consists of a cathode, an anode, a separator, and an electrolyte. Lithium-ion batteries currently used in smartphones, power tools, electric bicycles, and electric cars use liquid electrolytes. In contrast, an all-solid-state battery is a battery in which an electrolyte is solid rather than a liquid. Materials used as solid electrolytes of the related art include oxynitride-based materials such as LiPON, phosphate-based materials such as Li₂O—Al₂O₃—TiO₂—P₂O₅ (LATP), oxide-based materials such as garnet type lithium lanthanum zirconium oxide (LLZO) or perovskite type lithium lanthanum titanium oxide (LLTO), and sulfide-based materials such as binary sulfide, Li₂S−P₂S₅, or a thio-lithium super ionic conductor (thio-LISICON), Li₁₀GeP₂S₁₂.

In lithium-ion batteries, dendrites, which are crystals that accumulate in a tree shape on a surface of a Li metal (an anode material) during charging and discharging, are formed. Next-generation lithium-ion batteries use anode materials such as lithium metal instead of graphite anode materials of the related art to improve an energy density, and these dendrites may hinder the movement of lithium ions, resulting in a decrease in the charging and discharging efficiency and a shortened lifespan of lithium-ion batteries. To overcome this, research is conducted to prevent dendrite generation by applying nano-coating to a surface of an anode material or using a new material.

### SUMMARY

One or more embodiments may address at least the above problems and/or disadvantages and other disadvantages not described above. Also, the embodiments are not required to overcome the disadvantages described above, and an embodiment may not overcome any of the problems described above.

According to an aspect of one or more embodiments, there is provided an anode for an all-solid-state battery including an anode layer, and an interface layer on the anode layer, wherein the anode layer includes an anode active material, and wherein the interface layer includes a metal oxynitride satisfying MₓN_{y}O_{z}, where, M is one or more of silicon (Si), aluminum (Al), and hafnium (Hf), 0<x<1, 0<y<1, 0<z<1, and x+y+z=1.

The anode may satisfy x<y, and 0<z≤0.3.

At least one of carbon (C) and oxygen (O) may be on a surface of the interface layer in contact with the anode layer.

The anode may further include one or more buffer layers between the anode layer and the interface layer.

At least one of buffer layer of the one or more buffer layers may include one or more of a silver-carbon composite (AgC), germanium telluride (GeTe) oxide, hafnium (Hf) oxide, zirconium (Zr) oxide, germanium (Ge) oxide, selenium (Se) oxide, and telluride (Te) oxide.

A thickness of the interface layer may range from 1 nm to 1,000 nm.

The anode active material may include at least one of a lithium (Li)-based active material, a silicon (Si)-based active material, and a carbon (C)-based active material.

The anode active material may include a lithium (Li)-based active material, and the lithium (Li)-based active material may include lithium metal or lithium alloy.

According to another aspect of one or more embodiments, there is provided an all-solid-state battery including an anode layer, a solid electrolyte layer, a cathode layer, and an interface layer between the anode layer and the solid electrolyte layer, the interface layer including a metal oxynitride satisfying MₓN_{y}O_{z}, where M is one or more of silicon (Si), aluminum (Al), and hafnium (Hf), and 0<x<1, 0<y<1, 0<z<1, and x+y+z=1.

The all-solid-state battery may satisfy x<y and 0<z≤0.3.

The all-solid-state battery may further include one or more buffer layers on one surface or both surfaces of the interface layer.

At least one of the one or more buffer layers may include one or more of a silver-carbon composite (AgC), germanium telluride (GeTe) oxide, hafnium (Hf) oxide, zirconium (Zr) oxide, germanium (Ge) oxide, selenium (Se) oxide, and telluride (Te) oxide.

At least one of the one or more buffer layers may include one or more of lithium oxide, lithium nitride, lithium silicide, and lithium silicate.

The solid electrolyte layer may include one or more solid electrolytes of a sulfide-based solid electrolyte and an oxide-based solid electrolyte.

The sulfide-based solid electrolyte may include one or more of Li₂S—P₂S₅, Li₂S—P₂S₅—LiX (X is F, Cl, Br, or I), Li₂S—P₂S₅—Li₂O, Li₂S—P₂S₅—Li₂O—LiI, Li₂S—SiS₂, Li₂S—SiS₂—LiI, Li₂S—SiS₂—LiBr, Li₂S—SiS₂—LiCl, Li₂S—SiS₂—B₂S₃—LiI, Li₂S—SiS₂—P₂S₅—LiI, Li₂S—B₂S₃, Li₂S—P₂S₅—ZₘSₙ, where m and n are positive numbers, and Z is Ge, Zn, or Ga, Li₂S—GeS₂, Li₂S—SiS₂—Li₃PO₄, Li₂S—SiS₂-LiₚMO_{q}, where p and q are positive numbers, and M is P, Si, Ge, B, Al, Ga, or In, Li₇₋ₓPS₆₋ₓClₓ, where 0<x<2, Li₇₋ₓPS₆₋ₓBrₓ, where 0<x<2, and Li₇₋ₓPS₆₋ₓIₓ, where 0<x<2.

The oxide-based solid electrolyte may include one or more of Li_{1+x+y}AlₓTi₂₋ₓSi_{y}P_{3-y}O₁₂, where 0<x<2, and 0≤y<3, BaTiO₃, Pb (Zr,Ti)O₃ (PZT), Pb₁₋ₓLaₓZr_{1-y}Ti_{y}O₃ (PLZT), where 0≤x<1, and 0≤y<1, PB(Mg₃Nb_{2/3})O₃—PbTiO₃ (PMN-PT), HfO₂, SrTiO₃, SnO₂, CeO₂, Na₂O, MgO, NiO, CaO, BaO, ZnO, ZrO₂, Y₂O₃, Al₂O₃, TiO₂, SiO₂, Li₃PO₄, LiₓTi_{y} (PO₄)₃, where 0<x<2, and 0<y<3, LiₓAl_{y}Ti_{z} (PO₄)₃, where 0<x<2, 0<y<1, and 0<z<3, Li_{1+x+y}(Al, Ga)ₓ(Ti, Ge)₂₋ₓSi_{y}P_{3-y}O₁₂, where 0≤x≤1, and 0≤y≤1, LiₓLa_{y}TiO₃, where 0<x<2, and 0<y<3, Li₂O, LiOH, Li₂CO₃, LiAlO₂, Li₂O—Al₂O₃—SiO₂—P₂O₅—TiO₂—GeO₂, and Li₃₊ₓLa₃M₂O₁₂, where M is Te, Nb, or Zr, and x is an integer of 1 to 10.

The anode layer may include an anode current collector an anode active material layer, the anode active material layer may include a lithium (Li)-based active material, and the lithium (Li)-based active material may include lithium metal or lithium alloy.

According to still another aspect of one or more embodiments, there is provided a method of manufacturing an all-solid-state battery, the method including forming an anode active material layer on an anode current collector, forming an interface layer including a metal oxynitride on the anode active material layer, forming a solid electrolyte layer on the interface layer, and forming a cathode layer on the solid electrolyte layer, wherein the metal oxynitride satisfies MₓN_{y}O_{z}, where M is one or more of silicon (Si), aluminum (Al), and hafnium (Hf), and 0<x<1, 0<y<1, 0<z<1, and x+y+z=1.

The method may further include forming one or more buffer layers on the anode active layer, between the forming of the anode active material layer on the anode current collector and the forming of the interface layer including the metal oxynitride on the anode active material layer, wherein at least one of the one or more buffer layers may include one or more of AgC, GeTe oxide, Hf oxide, Zr oxide, Ge oxide, Se oxide, and Te oxide.

The forming of the interface layer including the metal oxynitride on the anode active material layer may be performed by sputtering, spin coating, drop coating, spray coating, physical vapor deposition (PVD), chemical vapor deposition (CVD), or solution infiltration.

### BRIEF DESCRIPTION OF DRAWINGS

The above and/or other aspects will be more apparent by describing one or more embodiments with reference to the accompanying drawings, in which:

FIG. 1A is a diagram illustrating an anode for an all-solid-state battery having a structure of anode current collector/anode active material layer/interface layer according to one or more embodiments;

FIG. 1B is a diagram illustrating an anode for an all-solid-state battery having a structure of anode current collector/anode active material layer/buffer layer/interface layer according to one or more embodiments;

FIG. 2A is a diagram illustrating an all-solid-state battery having a structure of anode current collector/anode active material layer/interface layer/solid electrolyte layer/cathode layer according to one or more embodiments;

FIG. 2B is a diagram illustrating an all-solid-state battery having a structure of anode current collector/anode active material layer/buffer layer/interface layer/solid electrolyte layer/cathode layer according to one or more embodiments;

FIG. 2C is a diagram illustrating an all-solid-state battery having a structure of anode current collector/anode active material layer/buffer layer/interface layer/buffer layer/solid electrolyte layer/cathode layer according to one or more embodiments;

FIG. 3 is a diagram illustrating an all-solid-state battery having a structure of anode current collector/anode active material layer/solid electrolyte layer/cathode layer according to a related example;

FIG. 4 is a diagram illustrating a cross section of an all-solid-state battery in which dendrites are formed in the all-solid-state battery according to a related example;

FIG. 5A is a diagram illustrating a band gap of a Li/LLZO structure;

FIG. 5B is a diagram illustrating a band gap of a Li/Si-rich silicon oxynitride (hereinafter, referred to as “Si-rich SiON”)/LLZO structure;

FIG. 5C is a diagram illustrating a band gap of a Li/N-rich silicon oxynitride (hereinafter, referred to as “N-rich SiON”)/LLZO structure;

FIG. 5D is a diagram illustrating a band gap of a Li/AgC/N-rich SiON/LLZO structure;

FIG. 6A is a Nyquist plot showing an impedance measurement result for an all-solid-state secondary battery formed of Li/LLZO/Li;

FIG. 6B is a Nyquist plot showing an impedance measurement result for an all-solid-state secondary battery formed of Li/SiON/LLZO/Li;

FIG. 6C is a Nyquist plot showing an impedance measurement result for an all-solid-state secondary battery formed of Li/AgC/SiON/LLZO/Li;

FIG. 7A is a diagram illustrating an evaluation result of electrochemical stability for a lithium symmetric cell formed of Li/LLZO/Li.

FIG. 7B is a diagram illustrating an evaluation result of electrochemical stability for a lithium symmetric cell formed of Li/SiON/LLZO/Li;

FIG. 7C is a diagram illustrating an evaluation result of electrochemical stability for a lithium symmetric cell formed of Li/AgC/SiON/LLZO/Li;

FIG. 8A shows a discharge capacity evaluation result for a full-cell all-solid-state battery formed of Li/LLZO/NCM;

FIG. 8B shows a discharge capacity evaluation result for a full-cell all-solid-state battery formed of Li/AgC/Si-rich SiN/LLZO/NCM;

FIG. 8C shows a discharge capacity evaluation result for a full-cell all-solid-state battery formed of Li/AgC/N-rich SiN/LLZO/NCM; and

FIG. 9 is a diagram illustrating a result of transmission electron microscope (TEM) analysis of an all-solid-state battery including an AgC/SiON/LLZO layer according to one or more embodiments.

### DETAILED DESCRIPTION

Hereinafter, the examples will be described in detail with reference to the accompanying drawings. When describing the examples with reference to the accompanying drawings, like reference numerals refer to like elements and a repeated description related thereto will be omitted.

It should be appreciated that embodiments of the disclosure and the terms used therein are not intended to limit the technological features set forth herein to particular embodiments and include various changes, equivalents, or replacements for a corresponding embodiment. In connection with the description of the drawings, like reference numerals may be used for similar or related components. It is to be understood that a singular form of a noun corresponding to an item may include one or more of the things, unless the relevant context clearly indicates otherwise. As used herein, “A or B”, “at least one of A and B”, “at least one of A or B”, “A, B or C”, “at least one of A, B and C”, and “at least one of A, B, or C,” may include any one of the items listed together in the corresponding one of the phrases, or all possible combinations thereof. Terms such as “1st”, “2nd”, or “first” or “second” may simply be used to distinguish the component from other components in question, and do not limit the components in other aspects (e.g., importance or order).

Unless otherwise defined, all terms including technical and scientific terms used herein have the same meaning as commonly understood by one of ordinary skill in the art to which the embodiments belong. It will be further understood that terms, such as those defined in commonly-used dictionaries, should be interpreted as having a meaning that is consistent with their meaning in the context of the relevant art and will not be interpreted in an idealized or overly formal sense unless expressly so defined herein.

When describing the embodiments with reference to the accompanying drawings, like reference numerals refer to like components and a repeated description related thereto will be omitted. In the description of embodiments, detailed description of well-known related structures or functions will be omitted when it is deemed that such description will cause ambiguous interpretation of the present disclosure.

In addition, the terms first, second, A, B, (a), and (b) may be used to describe constituent elements of the embodiments. These terms are used only for the purpose of discriminating one component from another component, and the nature, the sequences, or the orders of the components are not limited by the terms. It should be noted that if it is described that one component is “connected”, “coupled”, or “joined” to another component, a third component may be “connected”, “coupled”, and “joined” between the first and second components, although the first component may be directly connected, coupled, or joined to the second component.

A component, which has the same common function as a component included in any one embodiment, will be described by using the same name in other embodiments. Unless disclosed to the contrary, the description of any one embodiment may be applied to other embodiments, and the specific description of the repeated configuration will be omitted.

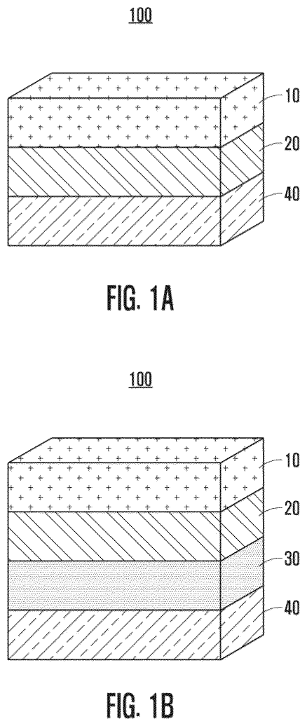

The effects of an electronic device according to one or more embodiments are not limited to the effects described below, and other unmentioned effects may be clearly understood from the following description by one of ordinary skill in the art. FIGS. 1A and 1B are cross-sectional views of an anode 100 for an all-solid-state battery according to one or more embodiments. Referring to FIG. 1A, the anode 100 includes an anode layer and an interface layer 40 disposed on the anode layer, and the anode layer includes an anode current collector 10 and an anode active material layer 20. For example, the interface layer 40 may be disposed on the anode active material layer 20.

According to one or more embodiments, the interface layer 40 may contain metal oxynitride represented by Chemical Formula 1:

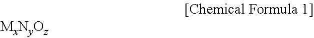

In Chemical Formula 1, M is one or more of silicon (Si), aluminum (Al), and hafnium (Hf), 0<x<1, 0<y<1, 0<z<1, and x+y+z=1.

For example, the metal oxynitride represented by Chemical Formula 1 may, as an example, correspond to N-rich metal oxynitride. In the N-rich metal oxynitride, when comparing the number of moles of metal (M) and nitrogen (N), the number of moles of nitrogen (N) is greater than the number of moles of metal (M). For example, in the metal oxynitride represented by MₓN_{y}O_{z} as in Chemical Formula 1, when x+y+z=1, y may be greater than x. For example, a z value of oxygen (O) may be less than or equal to 0.3. In the metal oxynitride, oxygen exists because oxygen is supplied during deposition of the interface layer. When the z value exceeds 0.3, a great SiO₂ phase may be formed, and thus, it may be less than or equal to 0.3.

In addition, the M may be one or more of Si, Al, and Hf, for example, may be SiₓN_{y}O_{z}, AlₓN_{y}O_{z}, or HfₓN_{y}O_{z}, and may be SiₐAl_{b}Hf_{c}N_{y}O_{z} (a+b+c=x, 0≤a≤x, 0≤b≤x, 0≤c≤x, and the definitions of x, y, and z are the same as in Chemical Formula 1), in which Si, Al, and Hf are partially substituted.

In addition, a by-product may be formed on a surface of the interface layer 40 in a direction of the anode active material layer 20, and therefore, substances such as carbon (C) or oxygen (O) may be distributed on the surface of the interface layer 40.

The interface layer 40 may have a thickness of, for example, 1 nanometer (nm) to 1,000 nm, for example 10 nm to 500 nm, or 50 nm to 200 nm, but is not limited thereto. When the thickness of the interface layer 40 is smaller than the above range, a function of increasing a conduction band offset (CBO) due to an increase in an energy band gap (a function of a blocking layer) may not be sufficiently performed, and when the thickness is greater than the above thickness range, the interface layer may act as resistance.

A band gap refers to an energy region in which electrons exist between energy bands showing an electronic state of a material to be obtained, and may generally refer to an energy gap present between a valence band filled with electrons and a conduction band that is empty.

When the energy gap of the band gap present between the valence band, which is completely filled with electrons, and the conduction band, which is completely empty, is much larger than energy corresponding to room temperature, the probability of electrons rising to the excited state of the conduction band is close to 0, and thus, the electrons may not move. On the other hand, when the energy gap of the band gap is about the energy corresponding to room temperature or smaller, the electrons in the valence band may more easily increase to the conduction band by crossing the band gap, and the electrons in this excited state and holes generated in the valence band may move relatively freely, thereby acting as a charge carrier that allows a current to flow.

The metal oxynitride of Chemical Formula 1, which is a material included in the interface layer 40, may be materials having a value greater than the band gap of a solid electrolyte, taking this band gap into consideration. The metal oxynitride of Chemical Formula 1 may be, as an example, N-rich metal oxynitride, and may be more for example N-rich SiₓO_{y}N_{z} (hereinafter, referred to as “N-rich SiON”).

Referring to FIG. 1B, the anode 100 may include the anode current collector 10, the anode active material layer 20 disposed on the anode current collector 10, and a buffer layer 30 disposed on the anode active material layer 20, and the interface layer 40 disposed on the buffer layer 30.

A lithium dendrite refers to a phenomenon in which lithium metal grows around a grain boundary due to inhomogeneous contact due to a deterioration of interfacial adhesion characteristics between a solid electrolyte and a lithium metal anode.

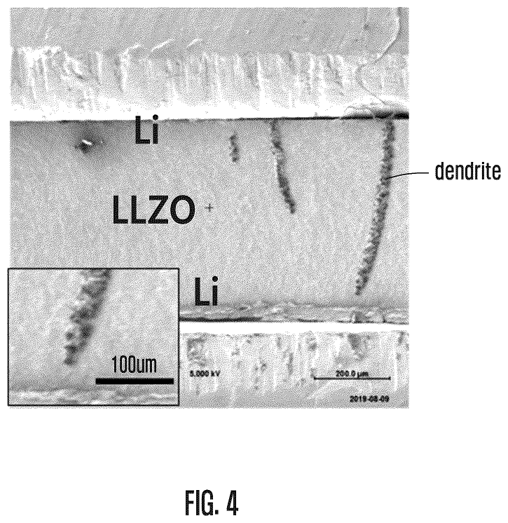

For example, referring to FIG. 4, it may be seen that dendrites are grown from an upper lithium anode downward through a solid electrolyte, LLZO.

The inhomogeneous contact due to the deterioration of interfacial adhesion characteristics may cause an increase in interfacial resistance between the solid electrolyte and the lithium metal, impeding the flow of a current within a battery. As a result, the local current density at a specific point may increase and the lithium dendrite growth may occur.

As described above, according to one or more embodiments, the interfacial adhesion characteristics between the anode active material and the solid electrolyte may be improved by sequentially arranging the buffer layer 30 and the interface layer 40 on the anode active material layer 20. In addition, the interfacial resistance between the solid electrolyte and the lithium metal may be improved, preventing the lithium dendrite growth, and as a result, the short performance of a battery may be improved while exhibiting relatively high charge and discharge characteristics.

The buffer layer 30 may include one or more materials of a silver-carbon composite (AgC), germanium telluride (GeTe) oxide, hafnium (Hf) oxide, zirconium (Zr) oxide, germanium (Ge) oxide, selenium (Se) oxide, and telluride (Te) oxide.

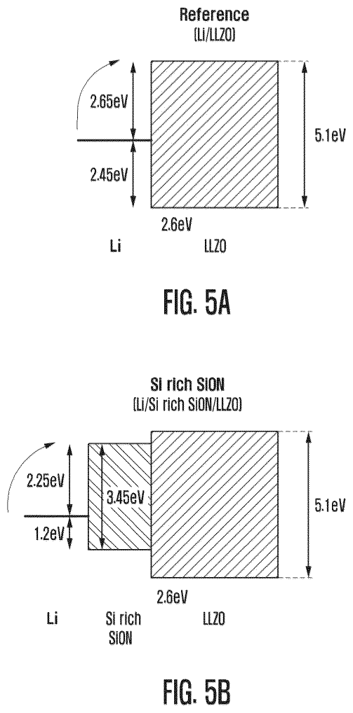

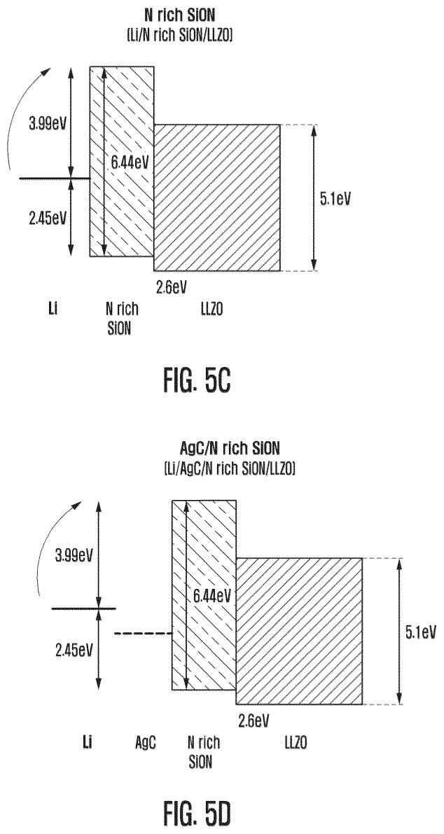

For example, the silver-carbon complex (AgC) corresponds to a material that lowers the Fermi level. Referring to FIG. 5D, it may be seen that, with the presence of the buffer layer 30 such as AgC, the Fermi level is lowered and a conduction band offset (CBO) is increased, and a function of a blocking layer of the interface layer 40 such as N-rich SiON may be more emphasized.

As described above, through the presence of the buffer layer 30 and the interface layer 40, the bonding strength between the anode layer and a solid electrolyte layer 50 may be further improved and a current may be prevented from concentrating, thereby more effectively preventing short circuits.

The presence of the buffer layer 30 and the interface layer 40 may be confirmed by methods such as X-ray photo electron spectroscopy (XPS), auger electron spectroscopy (AES), rutherford backscattering spectroscopy (RBS), and transmittance electron microscopy (TEM).

Referring to FIGS. 1A and 1B, the anode 100 according to one or more embodiments commonly includes the anode current collector 10 and the anode active material layer 20.

The anode current collector 10 may be formed of copper (Cu), stainless steel, titanium (Ti), iron (Fe), cobalt (Co), or nickel (Ni). In addition, the anode current collector 10 may be composed of one of the metals listed above, may be composed of metal alloy of two or more kinds thereof, and may be covered with another kind of metal. When a thin film is formed on a surface of the anode current collector 10, the thin film may contain an element that may form alloy with lithium. Elements that may form alloy with lithium may include, for example, gold, silver, zinc, tin, indium, silicon, aluminum, bismuth, etc. The thin film may be composed of one of these metals or of alloy of several kinds thereof.

The anode active material layer 20 may include one or more anode active materials of a lithium (Li)-based active material, a silicon (Si)-based active material, and a carbon (C)-based active material. Among these, in the all-solid-state battery according to one or more embodiments, short circuit performance and charge/discharge characteristics may be further improved, and the anode active material is desirably a lithium (Li)-based active material from a viewpoint of improving the energy density.

The lithium (Li)-based active material may include lithium metal or lithium alloy. Specific examples of the lithium alloy may include alloy including one or more selected from lithium, indium (In), silicon (Si), gallium (Ga), tin (Sn), aluminum (Al), titanium (Ti), zirconium (Zr), niobium (Nb), germanium (Ge), antimony (Sb), bismuth (Bi), gold (Au), platinum (Pt), palladium (Pd), magnesium (Mg), palladium (Pd), silver (Ag), and zinc (Zn). However, it is not limited thereto, and any metal or metalloid that may form alloy with any lithium available in the art may be used.

The silicon (Si)-based active material is an active material that does not form alloy with lithium, and examples thereof may be a silicon oxide-based active material, a silicon-carbon composite, nano-sized silicon particles, or silicon particles having a core-shell structure.

The carbon (C)-based active material is a material that does not contain lithium and silicon, and examples thereof may include graphite, soft carbon, hard carbon, carbon nanotubes, graphene, or carbon black.

The anode active material layer 20 may be appropriately mixed with additives such as a conductive agent, a binder, a filler, a dispersant, an ion conductivity auxiliary agent, etc.

The thickness of the anode layer may be, for example, about 1 μm to 100 μm, but is not limited thereto.

According to one or more embodiments, an all-solid-state battery may include an anode layer, the solid electrolyte layer 50, and a cathode layer 60 in this order, and may further include the interface layer 40 containing metal oxynitride represented by Chemical Formula 1 between the anode layer and the solid electrolyte layer 50:

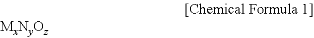

In Chemical Formula 1, M is one or more of Si, Al, and Hf, 0<x<1, 0<y<1, 0<z<1, and x+y+z=1.

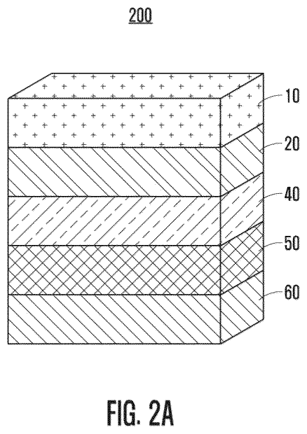

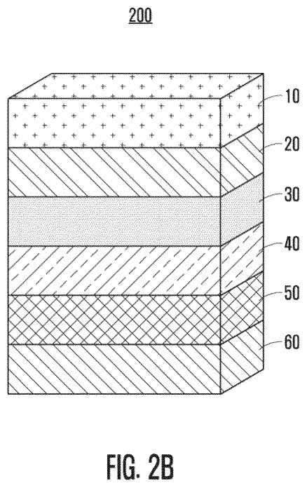

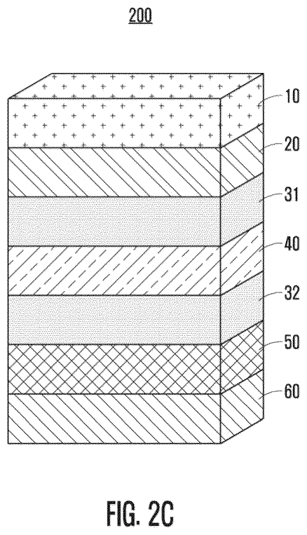

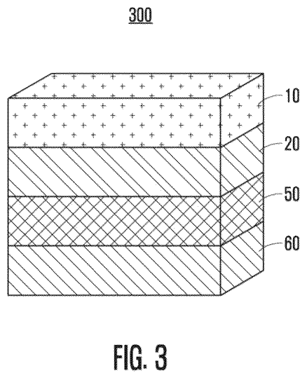

Referring to FIGS. 2A to 2C, an all-solid-state battery 200 includes an anode layer including the anode current collector 10 and the anode active material layer 20.

The anode current collector 10 and the anode active material layer 20 constituting the anode layer are substantially the same as the anode current collector 10 and the anode active material layer 20 in the anode 100 shown in FIGS. 1A and 1B. Since the description overlaps with the content described in detail previously, it will be omitted below.

The interface layer 40 of the all-solid-state battery according to one or more embodiments may be positioned between the solid electrolyte layer 50 and the anode layer. Referring to FIG. 2A, the interface layer 40 of the all-solid-state battery 200 may be positioned between the anode active material layer 20 constituting the anode layer and the solid electrolyte layer 50.

A by-product may be formed on a surface of the interface layer 40 in a direction of the anode active material layer 20 according to the charge and discharge of the all-solid-state battery 200, and therefore, substances such as carbon (C) or oxygen (O) may be distributed on the surface of the interface layer 40.

The interface layer 40 may contain metal oxynitride represented by Chemical Formula 1:

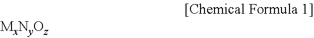

In Chemical Formula 1, M is one or more of Si, Al, and Hf, 0<x<1, 0<y<1, 0<z<1, and x+y+z=1.

For example, the metal oxynitride represented by Chemical Formula 1 may, as an example, correspond to N-rich metal oxynitride. For example, in the metal oxynitride represented by MₓN_{y}O_{z} as in Chemical Formula 1, when x+y+z=1, y may be greater than x. Here, oxygen (O) may be less than or equal to 0.3.

In addition, the M may be one or more of Si, Al, and Hf, for example, may be SiₓN_{y}O_{z}, AlₓN_{y}O_{z}, or HfₓN_{y}O_{z}, and may be SiₐAl_{b}Hf_{c}N_{y}O_{z} (a+b+c=x, O≤a≤x, 0≤b≤x, 0≤c≤x, and the definitions of x, y, and z are the same as in Chemical Formula 1), in which Si, Al, and Hf are partially substituted.

The interface layer 40 may have a thickness of, for example, 1 nm to 1,000 nm, for example 10 nm to 500 nm, or 50 nm to 200 nm, but is not limited thereto. When the thickness of the interface layer 40 is smaller than the above range, a function of increasing a CBO due to an increase in an energy band gap (a function of a blocking layer) may not be sufficiently performed, and when the thickness is greater than the above thickness range, the interface layer may act as resistance.

Referring to FIGS. 2B and 2C, one or more buffer layers 30, 31, and 32 may be additionally included between the anode active material layer 20 and the solid electrolyte layer 50, in addition to the interface layer 40.

The one or more buffer layers may be positioned on one surface or both surfaces of the interface layer 40.

When the one or more buffer layers include one or more materials of a silver-carbon composite (AgC), GeTe oxide, Hf oxide, Zr oxide, Ge oxide, Se oxide, and Te oxide, the buffer layer is desirably positioned on one surface of the interface layer 40 in a direction of the anode active material layer 20.

However, the one or more buffer layers may include one or more of lithium oxide, lithium nitride, lithium silicide, and lithium silicate, in addition to the materials listed above. These materials may generally be formed in small amounts through a side reaction, which is an interlayer overlap phenomenon between the interface layer 40 and the solid electrolyte 50, or the interface layer 40 and the anode active material layer 20 containing lithium metal. Therefore, it may be formed as a thin buffer layer on the surface of the interface layer 40, and does not significantly affect the performance of the anode or the all-solid-state battery according to one or more embodiments.

The thickness of the buffer layers 30, 31, and 32 may be, for example, about 1 nm to 50 nm, but is not limited thereto.

Referring to FIGS. 2A and 2B, the all-solid-state battery according to one or more embodiments includes the solid electrolyte layer 50 disposed between the interface layer 40 and the cathode layer 60.

The solid electrolyte may include, for example, a sulfide-based solid electrolyte, an oxide-based solid electrolyte, or a combination thereof.

The sulfide-based solid electrolyte includes one or more of Li₂S—P₂S₅, Li₂S—P₂S₅—LiX (X is F, Cl, Br, or I), Li₂S—P₂S₅—Li₂O, Li₂S—P₂S₅—Li₂O—LiI, Li₂S—SiS₂, Li₂S—SiS₂—LiI, Li₂S—SiS₂—LiBr, Li₂S—SiS₂—LiCl, Li₂S—SiS₂—B₂S₃—LiI, Li₂S—SiS₂—P₂S₅—LiI, Li₂S—B₂S₃, Li₂S—P₂S₅—ZₘSₙ (m and n are positive numbers, and Z is Ge, Zn, or Ga), Li₂S—GeS₂, Li₂S—SiS₂—Li₃PO₄, Li₂S—SiS₂—LiₚMO_{q} (p and q are positive numbers, and M is P, Si, Ge, B, Al, Ga, or In), Li₇₋ₓPS₆₋ₓClₓ (0<x<2), Li₇₋ₓPS₆₋ₓBrₓ (0<x<2), and Li₇₋ₓPS₆₋ₓIₓ (0<x<2). Also, the sulfide-based solid electrolyte may be amorphous, crystalline, or a mixture thereof.

For example, the sulfide-based solid electrolyte may contain sulfur(S), phosphorus (P), and lithium (Li) as at least constituent elements among sulfide-based solid electrolyte materials. In an example, the sulfide-based solid electrolyte may be a material containing Li₂S—P₂S₅.

The sulfide-based solid electrolyte may be a compound having an argyrodite crystal structure, and for example, an argyrodite-type compound containing one or more selected from Li₆PS₅Cl, Li₆PS₅Br, and Li₆PS₅I.

The oxide-based solid electrolyte includes one or more of Li_{1+x+y}AlₓTi₂₋ₓSi_{y}P_{3-y}O₁₂ (0<x<2, and 0≤y<3), BaTiO₃, Pb(Zr,Ti)O₃ (PZT), Pb₁₋ₓLaₓZr_{1-y}Ti_{y}O₃ (PLZT) (0≤x<1, and O≤y<1), PB(Mg₃Nb_{2/3})O₃—PbTiO₃ (PMN-PT), HfO₂, SrTiO₃, SnO₂, CeO₂, Na₂O, MgO, NiO, CaO, BaO, ZnO, ZrO₂, Y₂O₃, Al₂O₃, TiO₂, SiO₂, Li₃PO₄, LiₓTi_{y}(PO₄)₃ (0<x<2, and 0<y<3), LiₓAl_{y}Ti_{z}(PO₄)₃ (0<x<2, 0<y<1, and 0<z<3), Li_{1+x+y}(Al, Ga)ₓ(Ti, Ge)₂₋ₓSi_{y}P_{3-y}O₁₂ (0≤x≤1, and 0≤y≤1), LiₓLa_{y}TiO₃ (0≤x<2, and 0<y<3), Li₂O, LiOH, Li₂CO₃, LiAlO₂, Li₂O—Al₂O₃—SiO₂—P₂O₅—TiO₂—GeO₂, and Li₃₊ₓLa₃M₂O₁₂ (M is Te, Nb, or Zr, and x is an integer of 1 to 10).

For example, the oxide-based solid electrolyte is a garnet-type solid electrolyte selected from Li₇La₃Zr₂O₁₂ (LLZO) and Li₃₊ₓLa₃Zr₂₋ₐMₐO₁₂ (M doped LLZO, M=Ga, W, Nb, Ta, or Al, x is an integer of 1 to 10, and 0≤a<2).

The solid electrolyte may further include a binder. The binder included in the solid electrolyte may be, for example, styrene butadiene rubber (SBR), polytetrafluoroethylene (PTFE), polyvinylidene fluoride, polyethylene, or a combination thereof. However, embodiments are not limited thereto, and all binders may be possible.

The solid electrolyte may be in the form of a powder or a molded product. The solid electrolyte in the form of a molded product may be in the form of, for example, a pellet, a sheet, or a thin film, but is not necessarily limited thereto, and may have various forms depending on the purpose of use.

The thickness of the solid electrolyte layer 50 may be, for example, about 1 μm to 100 μm, but is not limited thereto. In addition, the solid electrolyte layer 50 may have a single layer or a multilayer structure of two or more layers.

According to one or more embodiments, the cathode layer 60 includes a cathode current collector and a cathode active material layer.

The cathode active material layer includes a cathode active material.

For the cathode current collector, a plate or a foil formed of, for example, indium (In), copper (Cu), magnesium (Mg), stainless steel, titanium (Ti), iron (Fe), cobalt (Co), nickel (Ni), zinc (Zn), aluminum (Al), germanium (Ge), lithium (Li), or alloy thereof may be used. In addition, the cathode current collector may be omitted.

The cathode active material may be a cathode active material capable of reversibly storing and releasing lithium ions. The cathode active material may be selected from lithium transition metal oxide, lithium transition metal phosphate, sulfide, or a combination thereof. For example, the cathode active material may be formed using lithium cobalt oxide (LCO), lithium nickel oxide, lithium nickel cobalt oxide, lithium nickel cobalt aluminum oxide (NCA), lithium nickel cobalt manganese oxide (NCM), lithium manganate, lithium iron phosphate, nickel sulfide, copper sulfide, lithium sulfide, iron oxide, or vanadium oxide, etc. These cathode active materials may be used alone or in combination of two or more kinds thereof. For example, the cathode active material may be a lithium salt of ternary transition metal oxide of LiNiₓCo_{y}Al₂O₂ (NCA) or LiNiₓCo_{y}Mn₂O₂ (NCM) (0<x<1, 0<y<1, 0<z<1, and x+y+z=1).

The cathode active material may have a coating layer formed on the cathode active material. All coating layers may be used as long as they are used as a coating layer of a cathode active material of an all-solid-state battery. As an example of the coating layer, Li₂O—ZrO₂ or the like may be used.

A shape of the cathode active material may be a particle shape such as ellipse or sphere. In addition, a particle diameter of the cathode active material is not limited, and may be used as long as it is within the range applicable to the cathode active material of the all-solid-state battery. A content of the cathode active material of the cathode layer 60 is also not limited, and may be used as long as it is within the range applicable to the cathode of the all-solid-state battery.

The thickness of the cathode layer 60 may be, for example, about 1 μm to 100 μm, but is not limited thereto.

The cathode layer 60 may contain not only the cathode active material and the solid electrolyte, but may also contain appropriate additives such as a conductive agent, a binder, a filler, a dispersant, and an ion conductivity auxiliary agent.

A method of manufacturing an all-solid-state battery includes forming an anode active material layer on an anode current collector, depositing an interface layer including a metal oxynitride represented by Chemical Formula 1 on the anode active material layer, arranging a solid electrolyte layer on the interface layer, and arranging a cathode layer on the solid electrolyte layer.

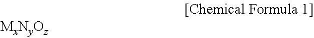

In Chemical Formula 1, M is one or more of Si, Al, and Hf, 0<x<1, 0<y<1, 0<z<1, and x+y+z=1.

The depositing of the interface layer including the metal oxynitride represented by Chemical Formula 1 on the anode active material layer may be performed by, for example, sputtering, spin coating, drop coating, spray coating, physical vapor deposition (PVD), chemical vapor deposition (CVD), or solution infiltration. Examples of the sputtering include DC sputtering, radio frequency (RF) sputtering, magnetron sputtering, bias sputtering, or reactive sputtering.

The method of manufacturing the all-solid-state battery according to one or more embodiments may further include forming one or more buffer layers on the anode active layer, between the forming of the anode active material layer on the anode current collector and the depositing of the interface layer including the metal oxynitride represented by Chemical Formula 1 on the anode active material layer. At least one of the one or more buffer layers may include one or more of AgC, GeTe oxide, Hf oxide, Zr oxide, Ge oxide, Se oxide, and Te oxide.

The forming of the one or more buffer layers on the anode active material layer may include forming by applying a composition for forming a buffer layer containing one or more of AgC, GeTe oxide, Hf oxide, Zr oxide, Ge oxide, Se oxide, and Te oxide, a binder, and a solvent. For specific examples, dipping, spin coating, drop casting, spray coating, spray pyrolysis, solution infiltration, roll coating, spray coating, dip coating, flow coating, doctor blade method, dispensing, inkjet printing, offset printing, screen printing, pad printing, gravure printing, flexo printing, or litho printing may be used. In addition, the solvent used in the composition for forming the buffer layer herein may be methanol, ethanol, dimethoxyethane, water, or a mixture thereof.

Hereinafter, examples and related examples of the present disclosure will be described. However, the following examples are merely an example of the present disclosure, and the present disclosure is not limited to the following examples.

According to Example 1 of manufacturing of Li/N-rich SiON/LLZO/Li lithium symmetric half-cell, a lithium metal layer was formed by laminating a lithium foil having a thickness of about 20 μm on a Cu current collector. An anode for an all-solid-state battery was manufactured by depositing an N-rich silicon oxynitride (SiON) interface layer having a thickness of about 100 nm on the lithium metal layer using a PVD sputter and a SiN target. A LLZO(Li₇La₃Zr₂O₂) solid electrolyte layer having a thickness of about 20 μm was disposed on the manufactured anode to manufacture an all-solid-state secondary battery (lithium symmetric half-cell) of Li/N-rich SiON/LLZO/Li.

According to Example 2 of manufacturing of Li/AgC/N-rich SiON/LLZO/Li lithium symmetric half-cell, the same method as in Example 1 was performed except for additionally depositing an AgC buffer layer on the lithium metal layer after forming the lithium metal layer and before depositing the interface layer. At this time, AgC was manufactured by adding Ag lumps to a carbon paste. As a result, an all-solid-state secondary battery (lithium symmetric half-cell) of Li/AgC/N-rich SiON/LLZO/Li was obtained.

According to Example 3 of manufacturing of Li/Si-rich SiON/LLZO/Li lithium symmetric half-cell, the same method as in Example 1 was performed except for manufacturing an anode for an all-solid-state battery by depositing a Si-rich silicon oxynitride (SiON) interface layer having a thickness of about 100 nm on the lithium metal layer. As a result, an all-solid-state secondary battery (lithium symmetric half-cell) of Li/AgC/Si-rich SiON/LLZO/Li was obtained.

According to Example 4 of manufacturing of Li/AgC/Si-rich SiON/LLZO/Li lithium symmetric half-cell, the same method as in Example 1 was performed except for additionally depositing an AgC buffer layer on the lithium metal layer, and then depositing a Si-rich silicon oxynitride (SiON) interface layer having a thickness of about 100 nm. As a result, an all-solid-state secondary battery (lithium symmetric half-cell) of Li/AgC/Si-rich SiON/LLZO/Li was obtained.

In a related Example 1 of manufacturing of Li/LLZO/Li lithium symmetric half-cell, a lithium metal layer was formed by laminating a lithium foil having a thickness of about 20 μm on a Cu current collector. A LLZO(Li₇La₃Zr₂O₂) solid electrolyte layer having a thickness of about 20 μm was disposed on the lithium metal layer to manufacture an all-solid-state secondary battery (lithium symmetric half-cell) of Li/LLZO/Li.

According to Example 5 of manufacturing of Li/AgC/N-rich SiON/LLZO/NCM all-solid-state secondary battery (full-cell), a lithium metal layer was formed by laminating a lithium foil having a thickness of about 20 μm on a Cu current collector. RF sputtering was performed on the lithium metal layer to sequentially deposit an AgC buffer layer and an N-rich silicon oxynitride (SiON) interface layer, to manufacture an anode for an all-solid-state battery.

A LLZO(Li₇La₃Zr₂O₂) solid electrolyte layer having a thickness of about 20 μm was disposed on the anode for the all-solid-state battery to prepare a laminate of anode layer/LLZO solid electrolyte layer.

LiNi_{0.33}Co_{0.33}Mn_{0.33}O₂ (NCM) was prepared as a As a cathode active material. In addition, PTFE was prepared as a binder. In addition, carbon nanofibers (CNF) were prepared as a conductive agent. Then, the above materials were mixed at a mass ratio of cathode active material:conductive agent:binder=100:2:1. The mixture was stretched into a sheet form to manufacture a cathode active material sheet. Then, the cathode active material sheet was pressed onto a cathode current collector formed of an aluminum foil having a thickness of 18 μm to manufacture a cathode layer. The cathode active material layer of the manufactured cathode layer was impregnated with an electrolyte solution in which LiFSI 2.0M was dissolved in an ionic liquid, N-propyl-Nmethyl-pyrrolidinium bis(fluorosulfonyl)imide (PYR13FSI).

The manufactured cathode layer was disposed on a LLZO solid electrolyte layer of the previously prepared laminate of anode layer/LLZO solid electrolyte layer, and then sealed to manufacture an all-solid-state secondary battery (full-cell) of Li/AgC/N-rich SiON/LLZO/NCM.

According to Example 6 of manufacturing of Li/AgC/Si-rich SiON/LLZO/NCM all-solid-state secondary battery (full-cell), the same method as in Example 5 was performed except for performing RF sputtering on the lithium metal layer to sequentially deposit an AgC buffer layer and a Si-rich silicon oxynitride (SiON) interface layer to manufacture an anode for an all-solid-state battery. As a result, an all-solid-state secondary battery (full-cell) of Li/AgC/Si-rich SiON/LLZO/NCM was obtained.

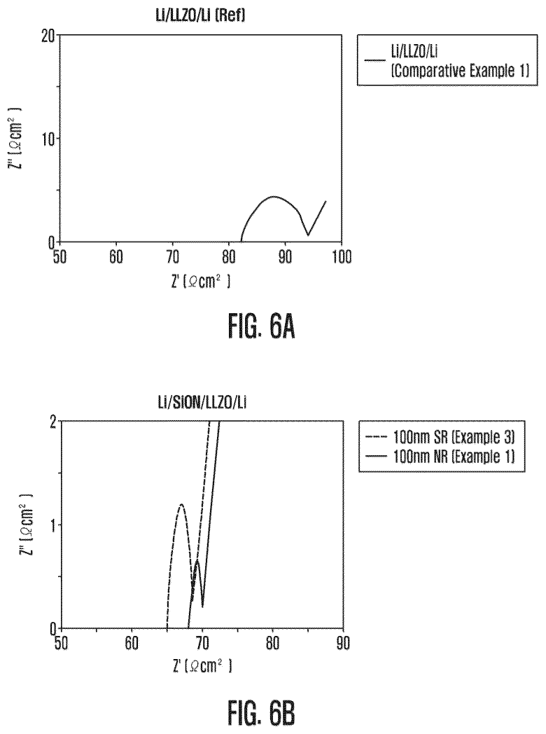

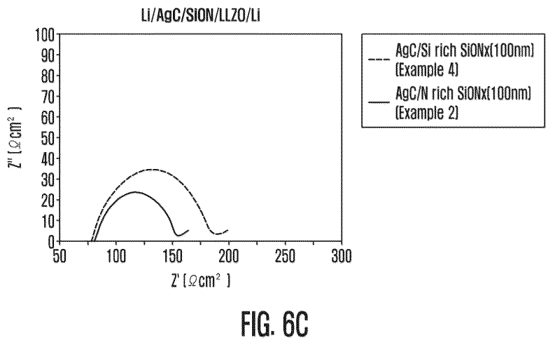

According to a related Example 2 of manufacturing of Li/LLZO/NCM all-solid-state secondary battery (full-cell), the same method as in Example 5 was performed except for forming a lithium metal layer by laminating a lithium foil having a thickness of about 20 μm on a Cu current collector, and disposing a LLZO(Li₇La₃Zr₂O₂) solid electrolyte layer having a thickness of about 20 μm on the lithium metal layer. As a result, an all-solid-state secondary battery (full-cell) of Li/LLZO/NCM was obtained.
Using the lithium symmetric half-cells of related Example 1 and Examples 1 to 4 manufactured, the impedance characteristics were evaluated at 25° C. The results are shown in the graphs of FIGS. 6A to 6C. Referring to FIGS. 6A to 6C, the resistance of Example 2 was greater than that of Example 1, and the resistance of Example 1 was relatively smaller than that of Example 3 (FIG. 6B). In addition, the resistance of Example 2 was relatively smaller than that of Example 4 (FIG. 6C).

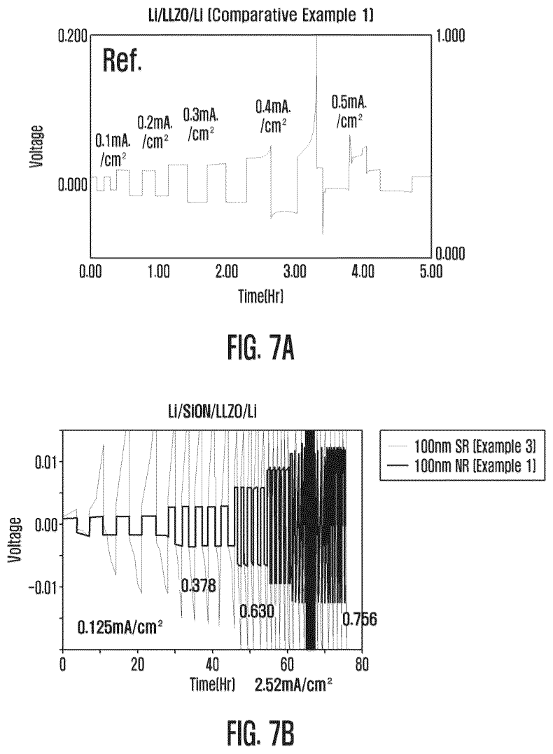

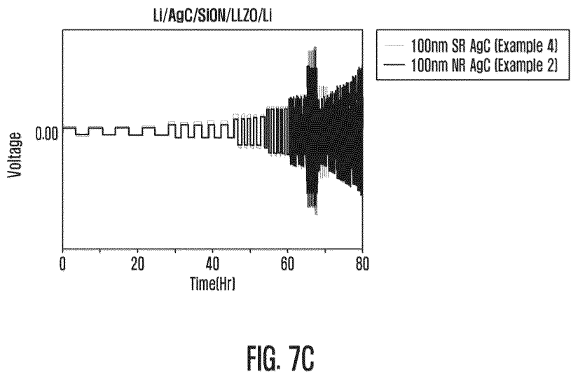

Electrochemical stability was evaluated using the lithium symmetric half-cells of related Example 1 and Examples 1 to 4 manufactured. The results are shown in the graphs of FIGS. 7A to 7C. Referring to FIGS. 7A to 7C, in related Example 1, a short circuit occurred at 0.4 mA/cm², however, in all of Examples 1 to 4, no short circuit occurred even at a current density higher than 0.4 mA/cm². It may be found that, in Examples 1 to 4, the short circuit characteristics were improved compared to related Example 1.

In addition, it may be found that, in each of Examples 3 and 4 with Si-rich SiON, the short circuit characteristics were improved, compared to each of Examples 1 and 2 with N-rich SiON, and it may be found that, in each of Examples 2 and 4 with AgC/SiON, the short circuit characteristics were improved, compared to each of Examples 1 and 3 with only SiON.

From these results, it may be found that Example 1 with AgC/SiON has most excellent short circuit characteristics.

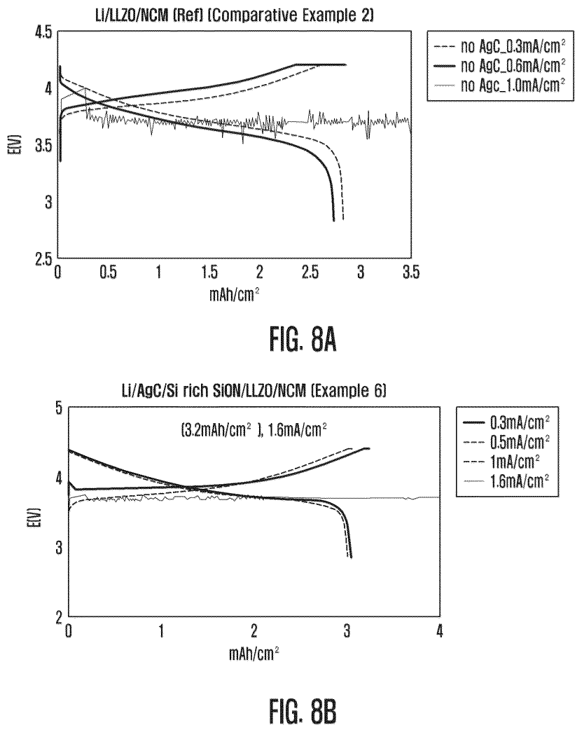

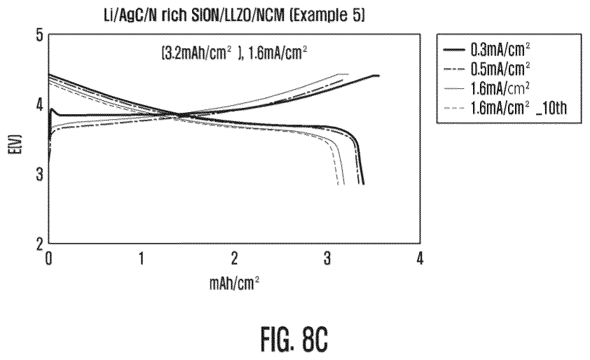

As illustrated in the graphs of FIGS. 8A to 8C, a charge/discharge test was conducted on the all-solid-state secondary batteries (full-cells) of related Example 2 and Examples 5 and 6 manufactured. For example, constant currents used in the charge/discharge tests of Related Example 2, Example 5, and Example 6 are shown in Table 1 below.

TABLE 1

| Cycle | Related Example 2 | Example 5 | Example 6 |
|---|---|---|---|
| First cycle | 0.3 mA/cm² | 0.3 mA/cm² | 0.3 mA/cm² |
| Second cycle | 0.6 mA/cm² | 0.5 mA/cm² | 0.5 mA/cm² |
| Third cycle | 1.0 mA/cm² | 1.6 mA/cm² | 1.0 mA/cm² |
| After fourth cycle | — | 1.6 mA/cm² | 1.6 mA/cm² |

As a result, the all-solid-state secondary battery of Example 5 with AgC/N-rich SiON did not deteriorate in charge/discharge efficiency even after an increase of the constant current and continuous charge/discharge cycles, compared to the secondary batteries of related Example 2 and Example 6. Accordingly, it may be found that all-solid-state secondary batteries with AgC/N-rich SiON have more improved stability.

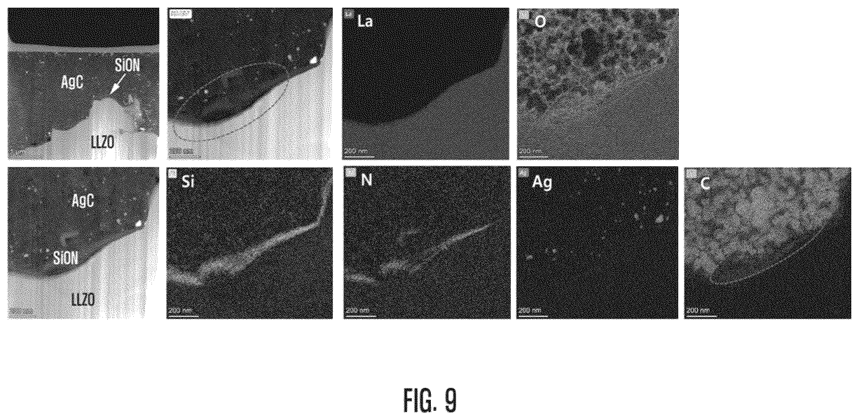

TEM images were observed for the all-solid-state secondary battery of Example 5 manufactured in Manufacturing examples, and the results are shown in FIG. 9.

Referring to FIG. 9, it may be confirmed that a SiON layer is clearly present between a LLZO layer and an AgC layer, and in particular, it may be confirmed that there are no significant side reactants between the LLZO layer and the SiON layer.

Accordingly, it may be found that the presence of the AgC/SiON layer may be sufficiently confirmed by methods such as XPS, AES, RBS, or TEM, and it may be found that the interlayer overlapping to the extent that the SiON layer or AgC layer is greatly diluted does not occur significantly.

While embodiments have been described with reference to the figures, it will be understood by those of ordinary skill in the art that various changes in form and details may be made therein without departing from the spirit and scope as defined by the following claims and their equivalents.

What is claimed is:

1. An anode for an all-solid-state battery comprising:
an anode layer; and
an interface layer on the anode layer,
wherein the anode layer comprises an anode active material, and
wherein the interface layer comprises a metal oxynitride satisfying: 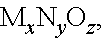
where, Mis one or more of silicon (Si), aluminum (Al), and hafnium (Hf), 0<x<1, 0<y<1, 0<z<1, and x+y+z=1.

2. The anode of claim 1, wherein, x<y, and 0<z≤0.3.

3. The anode of claim 1, wherein at least one of carbon (C) and oxygen (O) is on a surface of the interface layer in contact with the anode layer.

4. The anode of claim 1, further comprising:
one or more buffer layers between the anode layer and the interface layer.

5. The anode of claim 4, wherein at least one of buffer layer of the one or more buffer layers comprises one or more of a silver-carbon composite (AgC), germanium telluride (GeTe) oxide, hafnium (Hf) oxide, zirconium (Zr) oxide, germanium (Ge) oxide, selenium (Se) oxide, and telluride (Te) oxide.

6. The anode of claim 1, wherein a thickness of the interface layer ranges from 1 nm to 1,000 nm.

7. The anode of claim 1, wherein the anode active material comprises at least one of a lithium (Li)-based active material, a silicon (Si)-based active material, and a carbon (C)-based active material.

8. The anode of claim 1, wherein the anode active material comprises a lithium (Li)-based active material, and
wherein the lithium (Li)-based active material comprises lithium metal or lithium alloy.

9. An all-solid-state battery comprising:
an anode layer;
a solid electrolyte layer;
a cathode layer; and
an interface layer between the anode layer and the solid electrolyte layer, the interface layer comprising a metal oxynitride satisfying: 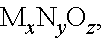
where M is one or more of silicon (Si), aluminum (Al), and hafnium (Hf), and 0<x<1, 0<y<1, 0<<<1, and x+y+z=1.

10. The all-solid-state battery of claim 9, wherein, x<y and 0<z≤0.3.

11. The all-solid-state battery of claim 9, further comprising:
one or more buffer layers on one surface or both surfaces of the interface layer.

12. The all-solid-state battery of claim 11, wherein at least one of the one or more buffer layers comprises one or more of a silver-carbon composite (AgC), germanium telluride (GeTe) oxide, hafnium (Hf) oxide, zirconium (Zr) oxide, germanium (Ge) oxide, selenium (Se) oxide, and telluride (Te) oxide.

13. The all-solid-state battery of claim 11, wherein at least one of the one or more buffer layers comprises one or more of lithium oxide, lithium nitride, lithium silicide, and lithium silicate.

14. The all-solid-state battery of claim 9, wherein the solid electrolyte layer comprises one or more solid electrolytes of a sulfide-based solid electrolyte and an oxide-based solid electrolyte.

15. The all-solid-state battery of claim 14, wherein the sulfide-based solid electrolyte comprises one or more of Li₂S—P₂S₅, Li₂S—P₂S₅—LiX (X is F, Cl, Br, or I), Li₂S—P₂S₅—Li₂O, Li₂S—P₂S₅—Li₂O—LiI, Li₂S—SiS₂, Li₂S—SiS₂—LiI, Li₂S—SiS₂—LiBr, Li₂S—SiS₂—LiCl, Li₂S—SiS₂—B₂S₃—LiI, Li₂S—SiS₂—P₂S₅—LiI, Li₂S—B₂S₃, Li₂S—P₂S₅—ZₘSₙ, where m and n are positive numbers, and Z is germanium (Ge), zinc (Zn), or gallium (Ga), Li₂S—GeS₂, Li₂S—SiS₂—Li₃PO₄, Li₂S—SiS₂-LiₚMO_{q}, where p and q are positive numbers, and Mis phosphorous (P), silicon (Si), germanium (Ge), boron (B), aluminum (Al), gallium (Ga), or indium (In), Li₇₋ₓPS₆₋ₓClₓ, where 0<x<2, Li₇₋ₓPS₆₋ₓBrₓ, where 0<x<2, and Li₇₋ₓPS₆₋ₓIₓ, where 0<x<2.

16. The all-solid-state battery of claim 14, wherein the oxide-based solid electrolyte comprises one or more of Li_{1+x+y}AlₓTi₂₋ₓSi_{y}P_{3-y}O₁₂, where 0<x<2, and 0≤y<3, BaTiO₃, Pb(Zr,Ti)O₃ (PZT), Pb₁₋ₓLaₓZr_{1-y}Ti_{y}O₃ (PLZT), where 0≤x<1, and 0≤y<1, PB(Mg₃Nb_{2/3})O₃—PbTiO₃ (PMN-PT), HfO₂, SrTiO₃, SnO₂, CeO₂, Na₂O, MgO, NiO, CaO, BaO, ZnO, ZrO₂, Y₂O₃, Al₂O₃, TiO₂, SiO₂, Li₃PO₄, LiₓTi_{y} (PO₄)₃, where 0<x<2, and 0<y<3, LiₓAl_{y}Ti_{z}(PO₄)₃, where 0<x<2,0<y<1, and 0<z<3, Li_{1+x+y}(Al, Ga)ₓ (Ti, Ge)₂₋ₓSi_{y}P_{3-y}O₁₂, where 0≤x≤1, and 0≤y≤1, LiₓLa_{y} TiO₃, where 0<x<2, and 0<y<3, Li₂O, LiOH, Li₂CO₃, LiAlO₂, Li₂O—Al₂O₃—SiO₂—P₂O₅—TiO₂—GeO₂, and Li₃₊ₓLa₃M₂O₁₂, where M is telluride (Te), niobium (Nb), or zirconium (Zr), and x is an integer of 1 to 10.

17. The all-solid-state battery of claim 9, wherein the anode layer comprises an anode current collector an anode active material layer,
wherein the anode active material layer comprises a lithium (Li)-based active material, and
wherein the lithium (Li)-based active material comprises lithium metal or lithium alloy.

18. A method of manufacturing an all-solid-state battery, the method comprising:
forming an anode active material layer on an anode current collector;
forming an interface layer comprising a metal oxynitride on the anode active material layer;
forming a solid electrolyte layer on the interface layer; and
forming a cathode layer on the solid electrolyte layer,
wherein the metal oxynitride satisfies: 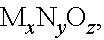
where Mis one or more of silicon (Si), aluminum (Al), and hafnium (Hf), and 0<x<1, 0<y<1, 0<z<1, and x+y+z=1.

19. The method of claim 18, further comprising:
forming one or more buffer layers on the anode active layer, between the forming of the anode active material layer on the anode current collector and the forming of the interface layer comprising the metal oxynitride on the anode active material layer,
wherein at least one of the one or more buffer layers comprises one or more of AgC, GeTe oxide, Hf oxide, Zr oxide, Ge oxide, Se oxide, and Te oxide.

20. The method of claim 18, wherein the forming of the interface layer comprising the metal oxynitride on the anode active material layer is performed by sputtering, spin coating, drop coating, spray coating, physical vapor deposition (PVD), chemical vapor deposition (CVD), or solution infiltration.
